(19) United States
(12) Patent Application Publication
(10) Pub. No.: US 2006/0152731 A1
(43) Pub. Date: Jul. 13, 2006

(54) SPECTROMETER

(75) Inventors: Werner Maentele, Blankenbach (DE); Oliver Klein, Frankfurt (DE); Gamze Hosafci, Offenbach (DE); Ernst Winter, Frankfurt (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Johann Wolfgang Goethe-Universitaet, Frankfurt am Main (DE)

(21) Appl. No.: 10/537,181

(22) PCT Filed: Dec. 1, 2003
(86) PCT No.: PCT/DE03/03950

§ 371 Date: Oct. 11, 2005

(30) Foreign Application Priority Data
Dec. 2, 2002 (DE) 102 56 188.5

(51) Int. Cl. G01N 21/55; G01J 3/30

(52) U.S. Cl. 356/445; 356/306

(57) ABSTRACT

A reflection spectrometer provided with a probe to which the radiation of at least one radiation source can be transmitted by at least one radiation emission conductor transmitter in such a way that said radiation source can be directed to or in an investigated object and which makes it possible to transmit radiation to or in an investigated object and/or emitted by such object to a radiation receiver that can be connected to an evaluation unit by means of at least one radiation emission conductor. The disclosure also relates to a transmitted light spectrometer which includes a probe to which the radiation of at least one radiation source can be transmitted by at least one radiation emission conductor in such a way that the radiation source can be directed to or in an investigated object. The spectrometer includes at least one remote radiation emission conductor of the probe which is used for transmitting radiation to or in an investigated object to a radiation receiver which can be connected to an evaluation unit.

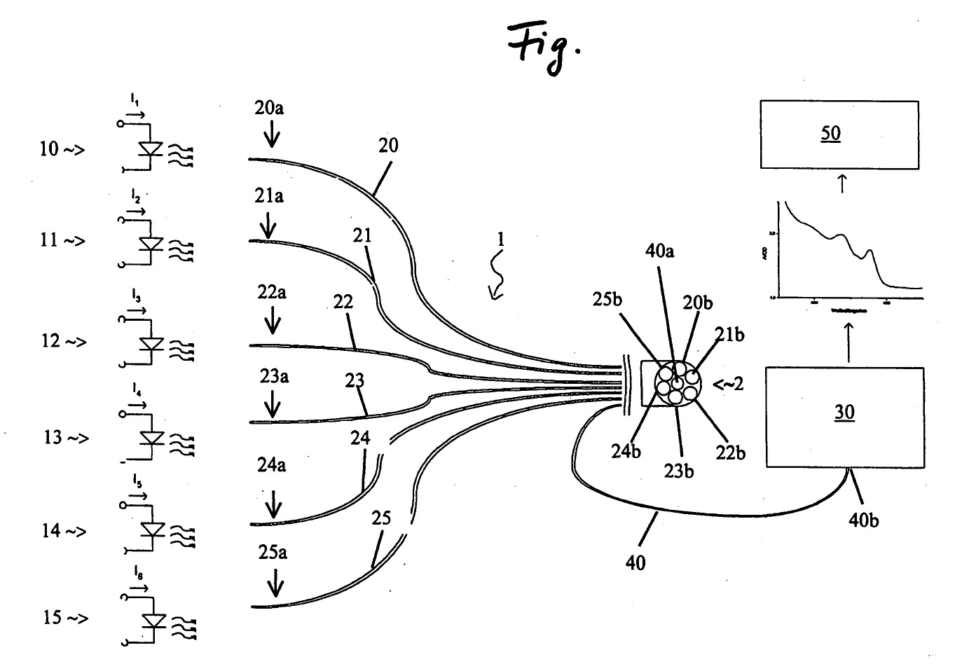

The invention concerns a spectrometer, especially a reflection spectrometer with a sensor to which, through at least one optical waveguide for emitted radiation, radiation of at least one radiation source can be introduced, in order to be directed on and/or in an object being investigated, and through which, with the aid of at least one optical waveguide for detected radiation, radiation reflected on and/or scattered by and/or emitted by the object to be investigated, especially fluorescent radiation, can be introduced to a radiation receiver, which can be connected to an evaluation unit. Furthermore, the invention is concerned with a transmission spectrometer with a sensor to which, the radiation of at least one radiation source can be introduced through an optical waveguide for emitted radiation, in order to direct it on and/or in an object to be investigated, and with at least one optical waveguide for detected radiation, through which radiation reflected on and/or scattered by and/or emitted by the object to be investigated, especially fluorescent radiation, can be introduced to a radiation receiver, which can be connected to an evaluation unit.

Such a reflection spectrometer is known, for example, from U.S. Pat. No. 6,045,502. The reflection spectrometer there serves in particular for the measurement of the concentration of bilirubin in a mammal by directing radiation onto a skin area of the mammal and analyzing the radiation scattered or reflected by the skin. For this purpose, a radiation source for emitting specific electromagnetic radiation or acoustic waves is provided while the radiation receiver with the evaluation unit is designed in the form of a spectrometer or diffraction grating in cooperation with a number of detectors in order to detect the intensity of previously-determined wavelengths. This limits the area of usage considerably, since the calculation of the different parameters requires completely different wavelength regions.

U.S. Pat. No. 6,104,938 also describes this type of reflection spectrometer for the determination of the amount of at least one light-absorbing substance in blood, where a radiation source is used which directs light with at least two specific central wavelengths onto the blood-containing tissue, so that the light reflected on the tissue can be received by the radiation receiver. In this reflection spectrometer, too, the area of application is very limited because of the specific predetermined data for the emission characteristics of the radiation source.

WO 00/09004 also describes a reflection spectrometer of this type, especially for the measurement of the arterial oxygen saturation. For this purpose, several radiation sources for different wavelength regions as well as narrow-band optical filters in front of photodetectors on the receiver side are provided, which again is contrary to a broad area of application.

DE 198 26 801 A1 describes an arrangement for minimizing the scattered light in spectral measuring apparatuses, and includes a light source, an inlet slit, an optical grating and a receiver. The method that is used here for the minimization of the scattered light in grating spectrometers is based on the sequential switching of light sources with different spectral regions. The light source, which can be formed from several individual light sources of different spectral radiation characteristics, emits in the individual wavelength regions in a time sequence. By arranging the individual spectra one after the other, one obtains continuous coverage of the wavelength region to be measured, where the receiver is designed for a time-sequential receipt of the individual wavelength regions and determines the total spectrum by superposition of the sequentially recorded individual spectra. The minimization of the scattered component is based on the fact that the wavelengths, which are perturbing individual measurements, are first of all not allowed at all or are not present. For spectral reflection measurements, DE 198 26 801 A1 uses, for example, a multi-channel LED light source in an Ulbricht ball, where a collecting lens is needed for bundling a collimated detected radiation in an optical fiber. If the individual radiated wavelength regions are combined by a fiber bundle with the number of inlet strands corresponding to the number of the individual light sources, the light source of the grating spectrometer according to DE 198 26 801 A1 can also be used for color measurement with 0°/45° measuring geometry, for spectral transmission and absorption measurement, as well as for the recording of ATR spectra. The problem of scattered light is solved accordingly with DE 198 26 801 A1 by the fact that the disturbing wavelength regions are temporarily extracted. First of all, the sensitivity and the range of application of the arrangement according to DE 198 26 801 A1 leaves things to be desired, but on the other hand, the arrangement of the apparatus that is proposed in this document is sensitive to mechanical influences and therefore the range of its possible applications is greatly limited.

Therefore, the task of the present invention is to develop this type of reflection spectrometer further in such a way that the disadvantages of the state of the art are overcome, especially so that the reflection spectrometer can be used in a variety of ways. Furthermore, the task of the present invention was to make available a transmission spectrometer of this type which is easy to manufacture, easy to operate, can be used in a variety of ways and is also characterized by a pronounced robustness against external mechanical influences.

This task with reference to the reflection spectrometer according to the invention is solved by the fact that a multiplicity of radiation sources is provided, the radiation intensities of each being adjustable, and having an emission spectrum that is broadband, either per radiation source or for all radiation sources together, and each of which is directly coupled with an optical waveguide for emitted radiation, the radiation detector receiving the entire spectrum of the radiation occurring in the optical waveguide for detected radiation by diffuse and/or directional reflection and/or fluorescence and at least the intensity of a given wavelength can be processed in the evaluation unit as a function of at least one program selectable for the calculation of at least one parameter.

In a further developed embodiment, the reflection spectrometer according to the invention additionally encompasses at least one optical waveguide for detected radiation at a distance from the sensor, through which to a radiation detector which can be connected to an evaluation unit, to which and/or in which the radiation scattered in or emitted by the object to be investigated or emitted by the object, especially fluorescent radiation can be introduced. This embodiment thus represents a combined reflection and transmission spectrometer.

The task of the invention with reference to the transmission spectrometer is solved by the fact that a number of radiation sources are provided, the radiation intensity of each one being adjustable, and having an emission spectrum which is broadband either per radiation source or for all radiation sources and which are coupled directly with an optical waveguide for emitted radiation, the radiation detector detecting the entire spectrum of the radiation occurring in the optical waveguide for detected radiation by diffuse and/or directional reflection, transmission, emission and/or fluorescence, and, in the evaluation unit, at least the intensity of one specific wavelength can be processed as a function of at least one program which can be selected through an operating unit for the calculation of at least one parameter.

The transmission spectrometer according to the invention or the embodiment of the transmission spectrometer according to the invention can be used especially effectively in the beverage industry, for example, for the determination of the components, the color and/or turbidity of fluids, for example, juices, mixed drinks or alcoholic beverages, such as beer. The axis of the exit of the light of the optical waveguide for emitted radiation and the axis of incidence of the light of the optical waveguide for detected radiation of opposite optical fibers for emitted radiation and optical fibers for detected radiation lie on a line or are directed parallel to one another. The inlet of the optical waveguide for detected radiation is in this case in the so-called forward direction. Alternatively, between the emission and detection axis of the optical waveguide for emitted radiation and optical waveguide for detected radiation can also be a fixed or variable angle not equal to 180°, which permits a greater constructive range.

Spectrometers are also preferred in which the axis of incidence of the radiation at least of a first next optical waveguide for detected radiation lies essentially on the line of the axis of the exit of the radiation of an optical fiber for emission radiation and/or is arranged essentially parallel to this, or in which the axis of incidence of the radiation of a second neighboring optical waveguide for detected radiation is at an angle not equal to 0°, 180° or 360°, especially 45°, 90°, 270° or 315°, to the radiation exit axis of the optical waveguide for emitted radiation. Here, for example, we can deal with a transmission spectrometer or also with a coupled or combined transmission- and reflection spectrometer. In this way, for example, with an incidence of the beam of the optical waveguide for emitted radiation introduced in the forward direction, the color of a liquid can be determined and with an incidence at an angle to this of a different optical waveguide for detected radiation, the turbidity of a liquid can be determined via detection of the scattered light. Preferably, the axis of incidence of the radiation of the optical waveguide for detected radiation and the exit axis of the radiation of the optical waveguide for emitted radiation lie essentially in one plane. In order to increase the sensitivity, the second neighboring optical waveguide for detected radiation has a variable angle setting to the exit axis of the radiation of the optical waveguide for emitted radiation. In this way, flexible scattered light maxima can be utilized for analysis. The incident and exit axes agree with the longitudinal axes of the optical waveguide for emitted radiation and optical waveguide for detected radiation when these are straight. If this is not the case, the respective tangents, laid at the end region of these optical fibers can be used for the determination of these incident and exit axes.

It can be provided that the radiation sources include cold light sources and/or semiconductors, preferably in the form of LEDs or lasers.

Furthermore, it can be provided that the radiation sources are all the same, emit in a broad band, or at least are partially different and emit in a specific spectral region.

According to another embodiment, it was found advantageous when at least two radiation sources emit in different or not completely overlapping spectral regions, especially with different intensities.

In an embodiment of the invention, the radiation sources can include at least one radiation source for emitting red light, at least one radiation source for emitting blue light and at least one radiation source for emitting green light.

Furthermore, it is proposed according to the invention that an optical waveguide for emitted radiation, preferably in the form of an optical fiber, especially a glass optical fiber, be applied on each radiation source with an optically transparent adhesive.

According to the invention, a screening of the optical waveguide for emitted radiation is proposed at least in the region of the adhesive on the radiation source, to prevent the coupling-in of stray light.

Furthermore, it can be provided that the housing of the radiation source, the adhesive and the optical waveguide for emitted radiation have the same refractive index, at least in the region of the adhesive.

It is also proposed by the invention that the optical waveguide for detected radiation, preferably in the form of an optical fiber, especially a glass optical fiber, be attachable, especially clampable into an opening gap of the radiation detector.

According to the invention it can be provided that in the sensor, preferably at the free end of the sensor, the radiation coupling-in end of the optical waveguide for detected radiation be surrounded by coupling-out ends of the optical waveguide for emitted radiation essentially in an annular manner so that in the measuring region and/or in the object to be investigated there is at least a partial overlap of the aperture of the optical waveguide for detected radiation and the aperture of the optical waveguide for emitted radiation.

A preferred embodiment of the invention can be characterized by the fact that the radiation detector includes an optical multichannel detector, especially a CCD detector or a diode array.

According to an especially advantageous embodiment, it is provided that in the evaluation unit it is possible to receive a number of individual spectra following each other in time, and especially that these can be stored, and quite especially be analyzed with consideration of their time sequence.

Especially, it can be provided that at least two, especially all, individual spectra be detectable at intervals in the region of microseconds to seconds. Especially preferably, the individual spectra are recorded at intervals of milliseconds to 10 seconds. These intervals may vary within a measured series, but they can also be kept constant. Usually the latter alternative is preferred. For example, with a rapid sequence of individual spectra, that is, with storing the spectral information at determined times, and time-resolved analysis of same, time-invariant parameters and those varying in time can be determined. For example, with the embodiment described above, it is possible to follow the oxygen concentration, especially the oxygen saturation of blood. If one resolves, for example, the spectral information in a pulsating part, one obtains the arterial oxygen concentration or oxygen saturation, while the constant part gives the capillary saturation or concentration, optionally with a component of the oxygen saturation of the venous blood.

It is also proposed with the invention that in the evaluation unit signals of the radiation detector can be resolved into a time-constant and time-variable especially pulsating component for separate evaluation.

Furthermore, it can be provided that programs be stored in the evaluation unit for the control of food products, for the determination of oxygen saturation and/or hemoglobin concentration in tissue, for the control of color, reflection and/or gloss properties of surfaces, colors and/or paints, for medical analysis, for process analysis and/or environmental analysis.

According to the invention it can be provided that the evaluation unit is in a working connection with the radiation sources in such a way that, depending on the selected program, the intensity of radiation emitted by each radiation source can be adjusted individually, especially by the current supply to the radiation sources.

It is also provided according to the invention that the sensor include an endoscope, that the sensor have a housing separate from that of the radiation sources and radiation detector and/or that the sensor can be handheld.

Furthermore, a display unit is proposed in working connection with the evaluation unit for displaying a given parameter.

Finally, it is provided according to the invention that the working connection between the radiation detector and the evaluation unit, between the evaluation unit and the operating unit, between the evaluation unit and display unit and/or between the evaluation unit and radiation source is telemetric and/or uses radio, infrared radiation or the internet. Furthermore, it is proposed according to the invention that at least one radiation source could be switched to pulsed operation at least for a period of time of a measurement or could be operated with a multiplex pattern.

In this connection it can be provided that at least two radiation sources can be switched into pulsed operation or can be operated with an individual multiplex pattern, where at least two radiation sources are emitting in different or only partially overlapping spectral regions. By using mediation sources switched in pulsed operation either individually or groupwise, as well as using radiation sources operated according to a multiplex pattern, it is possible to optimize the spectrometer according to the invention to a quite specific analytical task or to tailor it to it. For example, when the pulsed radiation sources or radiation sources operated with a certain multiplex pattern cover different spectral regions, the desired spectral information can be obtained through the evaluation unit with only a single light detector by corresponding demultiplexing.

Thus, the invention is based on the recognition that universal availability of a reflection spectrometer can be achieved when, on the other hand, the radiation sources can be selected for emitting a broadband spectrum, for example, in the form of white light, as well as the radiation detectors as suitable for detecting complete spectra, and, on the other hand, the intensity of the radiation of each radiation source as well as the wavelengths with the corresponding intensities which arrive from the radiation detector to the evaluation unit can be selected, so that with the same, using different software, various parameters can be determined as chosen. This and the possibility of miniaturization as well as the insensitivity to shock of the reflection spectrometer according to the invention, especially when using LEDs as cold light sources, glass optical fibers for the optical paths and a compact diode array or CCD (Charge Coupled Device)—spectrometers, not using lenses, mirrors or similar optical components, opens a variety of applications in a noninvasive mobile use, for example, for on-site control measurements in food control, such as the determination of the amount of carotenes, dyes, for quality control, for control of origin, for determination of the degree of ripeness or similar, for determination of the oxygen saturation and hemoglobin concentration in tissue, for example, in high-performance athletes, people suffering from sleep apnea, for the prevention of sudden infant death or similar, for color control, for example, the color comparison of textiles, cosmetics, selecting of toupees on similar, for medical analysis, for example for the investigation of blood in urine or stool or for environmental analysis, especially in the case of wastewater control. According to the invention one can also use a separation of radiation sources, the radiation detector and the sensor from one another, namely by using of optical fibers which also makes it possible to make measurements in an environment where there is a danger of explosions, in endoscopic interventions, in prenatal diagnostics or similar. A special advantage here is that the length of the path of the optical fiber from spectrometer to the actual measuring location of the sensor can be varied within a wide range and that this mechanical decoupling of sensor and spectrometer leads to an especially uncomplicated and disturbance-free handling. Finally, the reflection spectrometer according to the invention is characterized by a very simple and cost-effective manufacture which can be attributed, last but not least, to the fact that adjustment of the individual components of the reflection spectrometer is not necessary.

Other characteristics and advantages of the invention follow from the description of a practical example given below, with the aid of a drawing consisting of a single FIGURE. This FIGURE shows the reflection spectrometer schematically.

As can be seen from the FIGURE, a reflection spectrometer 1 according to the invention consists of a sensor 2, to which radiation can be led from radiation sources 10-15 through optical waveguides for emitted radiation 20-25 in order then to be directed onto a measured area which is not shown, such as the patient's skin, the surface of a food or similar. Sensor 2 is furthermore connected to a radiation detector 30 through an optical waveguide for detected radiation 40, where the radiation detector 30 in turn is connected to an evaluation unit 50.

Accordingly, in the case of the reflection spectrometer 1 shown, six radiation sources 10-15 are provided, for example, in the form of LEDs, of which always one pair emits red light (radiation sources 10, 13), blue light (radiation sources 11, 14) and green light (radiation sources 12, 15). In addition, the intensity of the radiation of each radiation source 10-15 can be selected by application of an adjustable current I₁ to I₆. Thus, using the six LEDs 10-15, radiation can be emitted essentially over the entire visible region of light at the free end of sensor 2.

To each LED 10-15 an optical waveguide for emitted light, in the form of a glass optical fiber 20-25 can be applied with their radiation coupling-in ends 20a-25a, using an adhesive, which is not shown, without reflection losses and without the insertion of stray light. The radiation coupling-out ends 20b-25b of the glass optical fibers 20-25 open into the free end of sensor 2 in such a way that they surround the radiation coupling-in end 40a of the optical waveguide for detected radiation in the form of a glass optical fiber in a circular manner. In this way, on two radially opposite sides of the radiation coupling-in end 40a the two radiation coupling-out ends 20b, 23b; 21b, 24b; 22b, 25b of a corresponding pair of LEDs 10, 13; 11, 14 or 12, 15 are arranged, and overlap the aperture of the glass optical fibers 20-25 in the measuring region with the aperture of the glass optical fiber 40, in order to provide universal applicability in this way.

The entire light, diffuse or directional reflected in the measurement range or fluorescent light emitted by the measuring range arrives through glass optical fiber 40 to the radiation detector 30, where the radiation coupling-out end 40b of the glass optical fiber 40 is clamped into an inlet gap of the radiation detector 30.

A number of programs can be deposited in the evaluation unit 50, and with each program a parameter can be determined, for example, the oxygen saturation or hemoglobin concentration in a tissue or the amount of carotene in foods. With an operating unit, which is not shown, a user of the reflection spectrometer 1 according to the invention can choose one of these programs so that the evaluation unit 50 searches for wavelengths selected from the radiation detector 30 depending on the selected program and then, based on the intensity of the received radiation at the said selected wavelengths, calculates the selected parameter. The calculated parameter can finally be displayed in a display unit, which is not shown.

With the reflection spectrometer 1 according to the invention, it is now possible for the first time to adjust an emitted spectrum in a simple manner with the aid of the current to be applied to the LEDs, for example, as a function of a selected program, through a working connection between the evaluation unit 50 and the LEDs 10-15, while the evaluation unit 50 at the same time can select special wavelengths from the total spectrum detected by diffuse or directional reflection from the radiation detector 30 for the determination of the desired parameter. In other words, using the same hardware, it is possible to calculate different parameters, whereby for the said calculation one only needs to run different programs via the software of the reflection spectrometer.

The characteristics of the invention disclosed in the above specification, in the claims and in the drawing can be essential for the realization of the invention in its various embodiments, both individually as well as in any arbitrary combination.

### REFERENCE LIST

1 Reflection spectrometer
2 Sensor
10-15 Radiation source
20-25 Optical waveguide for emitted radiation
20a-25a Radiation coupling-in end
20b-25b Radiation coupling-out end
30 Radiation detector
40 Optical waveguide for detected radiation
40a Radiation coupling-in end
40b Radiation coupling-out end
50 Evaluation unit

1. Transmission spectrometer comprising a sensor to which, through at least one optical waveguide for emitted radiation, the radiation of at least one radiation source can be introduced, in order to direct it on and/or in an object to be investigated, and with an optical waveguide for detected radiation spaced from the sensor, through which radiation, which was scattered by, transmitted by and/or emitted by the object to be investigated can be introduced to a radiation detector connected to an evaluation unit, the transmission spectrometer further comprising
a plurality of radiation sources, each having an adjustable radiation intensity, and which have an emission spectrum which is broadband either per radiation source or for all radiation sources together, and each of which is coupled directly to an optical waveguide for emitted radiation,
the radiation detector detecting the entire spectrum of the radiation which is entered in the optical waveguide for detected radiation by diffuse and/or directional reflection, transmission, emission and/or fluorescence, and
in the evaluation unit, as a function of at least one program which can be selected through an operating unit for the calculation of at least one parameter, at least the intensity of one given wavelength can be processed, and the evaluation unit is in working connection with the radiation sources in such a way that, depending on the selected program, the intensity of the radiation emitted from each radiation source can be adjusted individually, and wavelengths with corresponding intensities, which arrive from the radiation detector to the evaluation unit, can be selected.

2. Reflection spectrometer comprising a sensor to which, through at least one optical waveguide for emitted radiation, the radiation of at least one radiation source can be introduced, in order to direct it on and/or in an object to be investigated, and through which, with at least one optical waveguide for detected radiation, radiation, which was scattered by, transmitted by and/or emitted by the object to be investigated, can be introduced to a radiation detector connected to an evaluation unit, whereby at a free end of the sensor, a radiation coupling-in end of the optical waveguide for detected radiation is surrounded by radiation coupling-out ends of the optical waveguides for emitted radiation, so that in the measuring range on and/or in the object to be investigated, there is at least a partial overlap of the aperture of the optical waveguide for detected radiation with the aperture of the optical waveguide for emitted radiation, the radiation spectrometer further comprising
a plurality of radiation sources, each having an adjustable radiation intensity, and which have an emission spectrum which is broadband either per radiation source or for all radiation sources together, and each of which is coupled directly to an optical waveguide for emitted radiation,
the radiation detector detecting the entire spectrum of the radiation which is entered in the optical waveguide for detected radiation by diffuse and/or directional reflection and/or fluorescence, and
in the evaluation unit, as a function of at least one program which can be selected through an operating unit for the calculation of at least one parameter,
at least the intensity of one given wavelength can be processed and
the evaluation unit is in working connection with the radiation sources in such a way that, depending on the selected program, the intensity of the radiation emitted from each radiation source can be adjusted individually, and wavelengths with corresponding intensities, which arrive from the radiation detector to the evaluation unit can be selected.

3. Spectrometer according to claim 1, wherein the
radiation sources are selected from the group consisting of cold light sources and semiconductors.

4. Spectrometer according to claim 1,
wherein the radiation sources all emit equally in
broadband or at least partly differently in a specified spectral region.

5. Spectrometer according to of claim 1,
wherein at least two radiation sources emit in different or not completely overlapping spectral regions.

6. Spectrometer according to claim 4, wherein the radiation sources include at least one radiation source for emitting red light, at least one radiation source for emitting blue light and at least one radiation source for emitting green light.

7. Spectrometer according to claim 1, wherein the radiation detector includes an optical multi-channel detector.

8. Spectrometer according to claim 1, wherein in the evaluation unit a number of individual spectra can be deposited in a time sequence, and can be analyzed.

9. Spectrometer according to claim 8, wherein at least two, individual spectra can be received at intervals in the range of microseconds to seconds.

10. Spectrometer according to claim 1, wherein in the evaluation unit signals from the radiation detector can be resolved into a timewise constant and a timewise changeable, component for separate evaluation.

11. Spectrometer according to claim 1, wherein in the evaluation unit programs are stored for at least one of food control; determination of oxygen saturation and/or hemoglobin concentration in tissue; the control of the color, reflection and/or gloss properties of surfaces, dyes and/or paints; medical analysis; process analysis, and environmental analysis.

12. Spectrometer according to claim 1, wherein the sensor is surrounded by an endoscope, the sensor having a housing separate from the radiation sources and the radiation detector and/or the sensor can be handheld.

13. Spectrometer according to claim 1, wherein at least one radiation source can be switched at least for one time period of a measurement in pulsed operation or can be operated with a multiplex pattern.

14. Spectrometer according to claim 13, wherein at least two radiation sources in pulsed operation can be switched or each can be operated with an individual multiplex pattern, where at least two radiation sources are emitting in different or in only partially overlapping spectral regions.

15.-16. (canceled)

17. Spectrometer according to claim 2 wherein the radiation sources are selected from the group consisting of cold light sources and semiconductors.

18. Spectrometer according to claim 2, wherein the radiation sources all emit equally in broadband or at least partly differently in a specified spectral region.

19. Spectrometer according to of claim 2, wherein at least two radiation sources emit in different or not completely overlapping spectral regions.

20. Spectrometer according to claim 19, wherein the radiation sources include at least one radiation source for emitting red light, at least one radiation source for emitting blue light and at least one radiation source for emitting green light.

21. Spectrometer according to claim 2, wherein the radiation detector includes an optical multi-channel detector.

22. Spectrometer according to claim 2, wherein in the evaluation unit a number of individual spectra can be deposited in a time sequence, and can be analyzed.

23. Spectrometer according to claim 22, wherein at least two, individual spectra can be received at intervals in the range of microseconds to seconds.

24. Spectrometer according to claim 2, wherein in the evaluation unit signals from the radiation detector can be resolved into a timewise constant and a timewise changeable, component for separate evaluation.

25. Spectrometer according to claim 2, wherein in the evaluation unit programs are stored for at least one of food control; determination of oxygen saturation and/or hemoglobin concentration in tissue; control of the color, reflection and/or gloss properties of surfaces, dyes and/or paints; medical analysis; process analysis, and environmental analysis.

26. Spectrometer according to claim 2, wherein the sensor is surrounded by an endoscope, the sensor having a housing separate from the radiation sources and the radiation detector and/or the sensor can be handheld.

27. Spectrometer according to claim 2, wherein at least one radiation source can be switched at least for one time period of a measurement in pulsed operation or can be operated with a multiplex pattern.

28. Spectrometer according to claim 27, wherein at least two radiation sources in pulsed operation can be switched or each can be operated with an individual multiplex pattern, where at least two radiation sources are emitting in different or in only partially overlapping spectral regions.
